(19) United States
(12) Patent Application Publication
(10) Pub. No.: US 2015/0006138 A1
(43) Pub. Date: Jan. 1, 2015

(54) OPTICAL PROXIMITY CORRECTION FOR CONNECTING VIA BETWEEN LAYERS OF A DEVICE

(71) Applicant: Globalfoundries Inc., Grand Cayman (KY)

(72) Inventors: Guo Xiang Ning, Ballston Lake, NY (US); Fang Hong Gn, Singapore (SG); Paul Ackmann, Gansevoort, NY (US); Chin Teong Lim, Dresden (DE)

(21) Appl. No.: 13/932,141

(22) Filed: Jul. 1, 2013

(51) Int. Cl. G06F 17/50

(52) U.S. Cl. CPC G06F 17/5009
USPC 703/13

(57) ABSTRACT

Approaches for simulating a photolithographic process are provided. Specifically, provided is an optical proximity correction (OPC) model that includes kernel parameters corresponding to inter-layer activity and an etch process for a connecting via of an integrated circuit (IC). A resultant intensity is determined for a corresponding plurality of process variations corresponding to the interlayer activity and the etch process. As such, the OPC model considers both interlay activity and etch process.

### BACKGROUND

1. Technical Field

This invention relates generally to optical proximity correction (OPC) and, more particularly, to OPC for a connecting via between layers of an integrated circuit (IC) device.

2. Related Art

Lithography technology used for fabricating semiconductor devices may employ a process of transcribing a pattern, which may be formed on a photomask through an optical lens, onto a wafer. With increasing integration density of semiconductor devices, the dimensions of mask patterns may approximate wavelengths of light, such that the lithography process may be increasingly affected by diffraction and interference of light.

Because a spatial frequency may be lower if a mask pattern is larger in size or is transferred with a higher number of repetitions, many different frequencies may be capable of transmitting the mask pattern, resulting in a structural pattern, which may approximate an original mask pattern onto a wafer. However, generally, portions of higher frequencies may cause pattern distortions in “roundish” shapes. Such pattern distortions may be caused by an “optical proximity effect” (OPE). Because the spatial frequency may increase as a pattern size is reduced, the number of frequencies permissible to transmit the reduced pattern may decrease such that the pattern distortion due to OPE may likewise become more severe.

Optical proximity correction (OPC) may at least partially reduce pattern distortion due to OPE. OPC may involve adjusting an expected pattern distortion by intentionally altering an original mask pattern. OPC may improve an optical resolution and a pattern transfer fidelity. A conventional OPC process may include adding or removing small patterns, which may typically be less than the designed resolution, to or from a mask pattern associated with the photomask (e.g., line-end treatment or insertion of scattering bars).

After a photolithography processing technique, the following may be performed: design rule checking (DRC), an electrical rule checking, electrical parameter evaluation (EPE), layout-versus-schematic (LVS) according to checking and evaluation operations, and a layout process. Further, an additional step of intentionally altering a layout pattern using an OPC process may be performed.

OPC processes may be generally classified as a rule-based process for processing layout data (e.g., employing user-established rules), and a model-based process correcting a layout configuration based on a mathematical model of the lithography system. The conventional rule-based process may be carried out by altering or adjusting a layout based on one or more rules, such as partially cutting away primitive patterns and/or adding subsidiary patterns thereto. The rule-based process may be performed relatively quickly because the layout data corresponding to the entire chip area may be affected at a given time. However, it may be difficult to establish valid rules to employ during the rule-based process (e.g., rules which work effectively for any number of possible mask transfers). For example, a tedious process of experimental trial and error may be performed in order to establish the rules. Further, the trial and error process may continue indefinitely as new rules are employed to further optimize the system.

The model-based process may be conducted by correcting deformation of mask patterns by applying a model of a lithography system to a negative feedback system. Unfortunately, because of repetitive calculation, the model-based process may consume a significant amount of time and processing power to simulate a relatively small amount of data. However, the model-based process may be more likely than the rule-based process to eventually arrive at an optimized solution for the OPC process irrespective of a configuration of pattern. The model-based process may arrive at an acceptable solution even if no rules have been previously established (e.g., via the rule-based process), and further may be used to find a rules for an application of the rule-based process. However, the given OPC model may not sufficiently model particular shapes of selected patterns and features (e.g., a connecting via).

### SUMMARY

In general, approaches for simulating a photolithographic process are provided. Specifically, provided is an optical proximity correction (OPC) model that includes kernel parameters corresponding to inter-layer activity and an etch process for a connecting via of an integrated circuit (IC). A resultant intensity is determined for a corresponding plurality of process variations corresponding to the interlayer activity and the etch process. As such, the OPC model considers both interlay activity and etch process effect by one criteria, and no additional etch models are needed to reduce cycle times.

One aspect of the present invention includes a method for simulating a photolithographic process, the method comprising the computer implemented steps of: receiving a plurality of kernels characterizing an optical proximity correction (OPC) model of a connecting via between a set of layers of an integrated circuit (IC) device, each of the kernels dependent on at least one process variation associated with the photolithographic process; and determining a resultant intensity for a corresponding plurality of process variations from the plurality of kernels, wherein a process variation associated with at least one kernel corresponds to an interlayer activity, and wherein a process variation associated with at least another kernel corresponds to an etch process.

Another aspect of the present invention includes a system for simulating a photolithographic process, the system comprising: a processor; and a computer readable storage medium storing instructions, the instructions when executed by the processor causing the system to: receive a plurality of kernels characterizing an optical proximity correction (OPC) model of a connecting via between a set of layers of an integrated circuit (IC) device, each of the kernels dependent on at least one process variation associated with the photolithographic process; and determine a resultant intensity for a corresponding plurality of process variations from the plurality of kernels, wherein a process variation associated with at least one kernel corresponds to an interlayer activity, and wherein a process variation associated with at least another kernel corresponds to an etch process.

Yet another aspect of the present invention provides modeling of an optical proximity correction (OPC), the method comprising: receiving a plurality of kernels characterizing a connecting via between a set of layers of an integrated circuit (IC) device, each of the kernels dependent on at least one process variation associated with the photolithographic process; and determining, using a computer processor, a resultant intensity for a corresponding plurality of process variations from the plurality of kernels, wherein a process variation associated with at least one kernel corresponds to an interlayer activity, and wherein a process variation associated with at least another kernel corresponds to an etch process.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a schematic of an exemplary computing environment according to illustrative embodiments;

FIG. 2 shows a cross-sectional view of the IC device according to illustrative embodiments;

FIG. 3 shows a cross-sectional view of the IC device according to illustrative embodiments;

FIG. 4 shows a top view of the IC device according to illustrative embodiments;

FIG. 5 shows a schematic of an exemplary OPC flow according to illustrative embodiments;

FIG. 6 shows a top view of the IC device according to illustrative embodiments; and

FIGS. 7A-7B show exemplary images of an IC device before and after photolithographic processing using the etch selectivity kernel according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Exemplary embodiments will now be described more fully herein with reference to the accompanying drawings, in which exemplary embodiments are shown. Described are methods and techniques used for simulating a photolithographic process. Specifically, provided is an OPC model that includes kernel parameters corresponding to inter-layer activity and an etch process for a connecting via of an integrated circuit (IC). A resultant intensity is determined for a corresponding plurality of process variations corresponding to the interlayer activity and the etch process. As such, the OPC model considers both interlay activity and etch process effect by one criteria, and no additional etch models are needed to reduce cycle times.

It will be appreciated that this disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. The terminology used herein is for the purpose of describing particular embodiments only and is not intended to be limiting of this disclosure. For example, as used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” “exemplary embodiments,” or similar language means that a particular feature, structure, or characteristic described in connection with the embodiment is included in at least one embodiment of the present invention. Thus, appearances of the phrases “in one embodiment,” “in an embodiment,” “in embodiments” and similar language throughout this specification may, but do not necessarily, all refer to the same embodiment.

The terms “overlying” or “atop”, “positioned on” or “positioned atop”, “underlying”, “beneath” or “below” mean that a first element, such as a first structure, e.g., a first layer, is present on a second element, such as a second structure, e.g. a second layer, wherein intervening elements, such as an interface structure, e.g. interface layer, may be present between the first element and the second element.

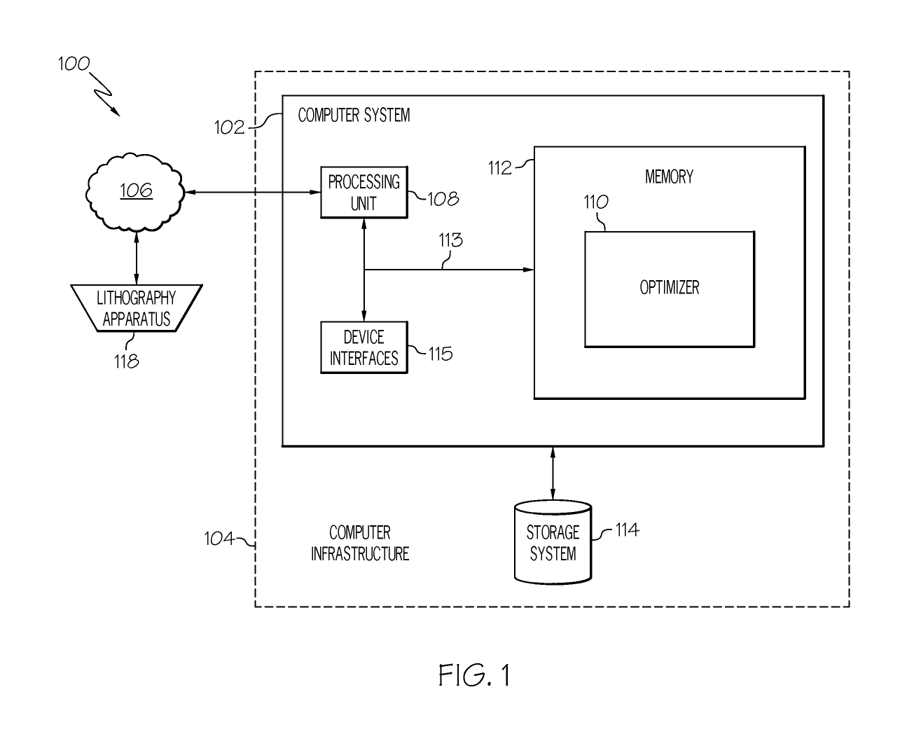

With reference now to the figures, FIG. 1 depicts a system 100 that facilitates simulation of an OPC model for a connecting via. As shown, system 100 includes computer system 102 deployed within a computer infrastructure 104. This is intended to demonstrate, among other things, that embodiments can be implemented within a network environment 106 (e.g., the Internet, a wide area network (WAN), a local area network (LAN), a virtual private network (VPN), etc.), a cloud-computing environment, or on a stand-alone computer system. Still yet, computer infrastructure 104 is intended to demonstrate that some or all of the components of system 100 could be deployed, managed, serviced, etc., by a service provider who offers to implement, deploy, and/or perform the functions of the present invention for others.

Computer system 102 is intended to represent any type of computer system that may be implemented in deploying/realizing the teachings recited herein. In this particular example, computer system 102 represents an illustrative system for optimizing an OPC model for a connecting via. It should be understood that any other computers implemented under various embodiments may have different components/software, but will perform similar functions. As shown, computer system 102 includes a processing unit 108 capable of operating with a optimizer 110 stored in a memory unit 112 to provide data center cooling, as will be described in further detail below. Also shown is a bus 113, and device interfaces 115.

Processing unit 108 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 108 receives signals transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 108 executes computer program code, such as program code for operating optimizer 110, which is stored in memory unit 112 and/or storage system 114. As will be further described below in more detail, in one embodiment, optimizer 110 is configured to receive a plurality of kernels characterizing an optical proximity correction (OPC) model of a connecting via between a set of layers of an integrated circuit (IC) device, each of the kernels dependent on at least one process variation associated with the photolithographic process; and determine a resultant intensity for a corresponding plurality of process variations from the plurality of kernels, wherein a process variation associated with at least one kernel corresponds to an interlayer activity, and wherein a process variation associated with at least another kernel corresponds to an etch process.

While executing computer program code, processing unit 108 can read and/or write data to/from memory unit 112 and storage system 114. Storage system 114 may comprise VCRs, DVRs, RAID arrays, USB hard drives, optical disk recorders, flash storage devices, and/or any other data processing and storage elements for storing and/or processing data. Although not shown, computer system 102 could also include I/O interfaces that communicate with one or more hardware components of computer infrastructure 104 that enable a user to interact with computer system 102 (e.g., a keyboard, a display, camera, etc.). As will be described in further detail below, optimizer 110 of computer infrastructure 104 is configured to operate with a lithography apparatus 118 for patterning features of an IC.

Although not shown in detail for the sake of brevity, it will be appreciated that in an exemplary embodiment, lithography apparatus 118 may comprise an illumination system (illuminator) configured to condition a radiation beam (e.g. UV radiation or DUV radiation); a support structure (e.g. a mask table) constructed to hold a patterning device (e.g. a mask); a substrate table (e.g. a wafer table) constructed to hold a substrate (e.g. a resist-coated wafer); and a projection system (e.g. a refractive projection lens system) configured to project a pattern imparted to the radiation beam by patterning device onto a target portion (e.g. comprising one or more dies) of the substrate.

The illumination system of lithography apparatus 118 may include various types of optical components, such as refractive, reflective, magnetic, electromagnetic, electrostatic or other types of optical components, or any combination thereof, for directing, shaping, or controlling radiation. The support structure holds the patterning device in a manner that depends on the orientation of the patterning device, the design of the lithographic apparatus, and other conditions, such as, for example, whether or not the patterning device is held in a vacuum environment. The support structure can use mechanical, vacuum, electrostatic or other clamping techniques to hold the patterning device.

During operation, the illuminator of lithography apparatus 118 receives a radiation beam from a radiation source. The illuminator may comprise an adjuster configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. The illuminator may be used to condition the radiation beam, and to have a desired uniformity and intensity distribution in its cross-section. The radiation beam is incident on the patterning device (e.g., mask), which is held on the support structure, and is patterned by the patterning device. Having traversed the patterning device, the radiation beam passes through the projection system, which focuses the beam onto a target portion of the substrate.

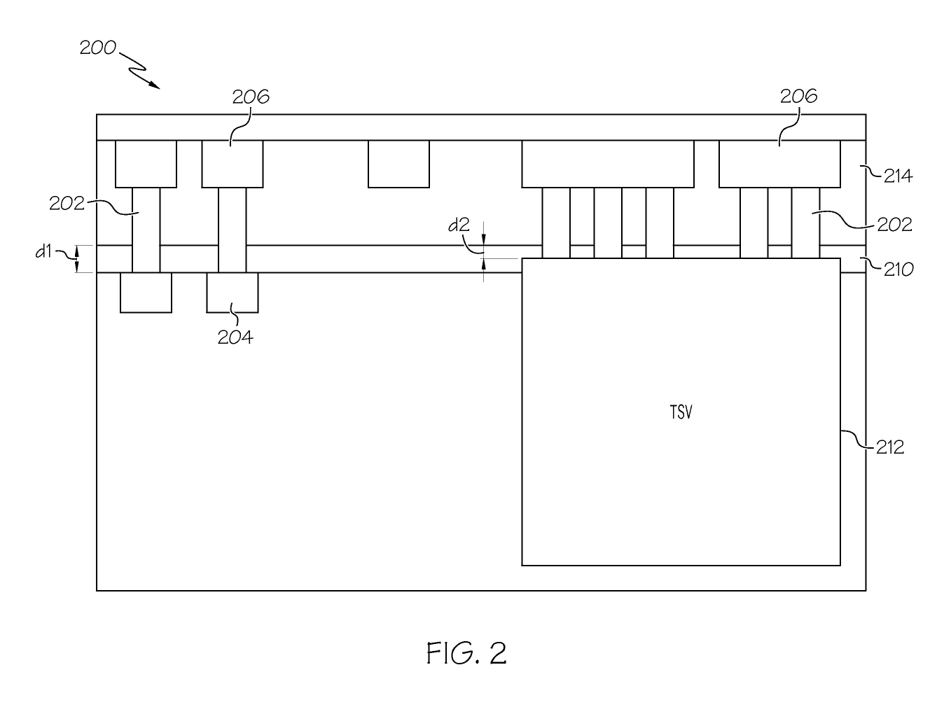

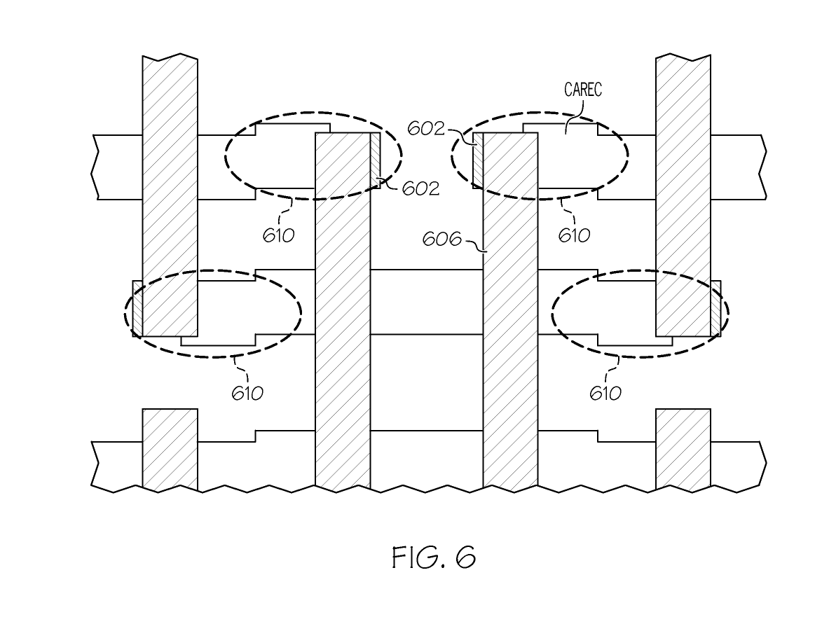

Referring now to FIG. 2, approaches for simulating a photolithographic process of a connecting via using OPC will be described in greater detail. As shown, IC 200 comprises a connecting via 202 (e.g., a through-silicon-via (TSV)) that connects different layers of IC 200. In an exemplary embodiment, connecting via 202 connects a contact layer 204 with a metal 1 (M1) layer 206 of IC 200. However, it'll be appreciated that this approach may be applied to other layers of IC 200, e.g., a polysilicon layer and rectangular contact (CArec) layer (later described and shown in more detail in FIG. 6).

As discussed above, embodiments herein provide built-in intelligence to a model for applying selective compensation based on process and design configurations, wherein the selective compensation introduces two parameters (ρ for interlayer activity and e₁ for an etch process) in an OPC polygons equation for a TSV process. In exemplary embodiments, a difference in measured light intensity is used to detect and quantify errors of the simulated process. The intensity T for connecting via 202 to TSV can be shown in the following Equation (1).

I=I(other optical parameters . . . ρ,e₁) Equation (1)

In equation (1), ρ and e₁ are two new kernel parameters for, respectively, inter-layer activity and etch process for the TSV process. FIG. 2 demonstrates an inter-layer effect (i.e., a relative displacement between layers) for ρ and e₁. In this embodiment, the kernel parameter ρ for inter-layer activity may be a function of distances d1 and d2, wherein d1 represents a vertical height or thickness of a first layer 210, and d2 represents a distance between a top surface of TSV 212 and a second layer 214. This is shown in FIG. 2, and defined by the following equation (2):

p=f(d1,d2,etc.) Equation (2)

It will be appreciated that many other parameters may be included in equation (2). However, for the sake of simplicity, only the effect of d1 and d2 on ρ are considered in detail herein.

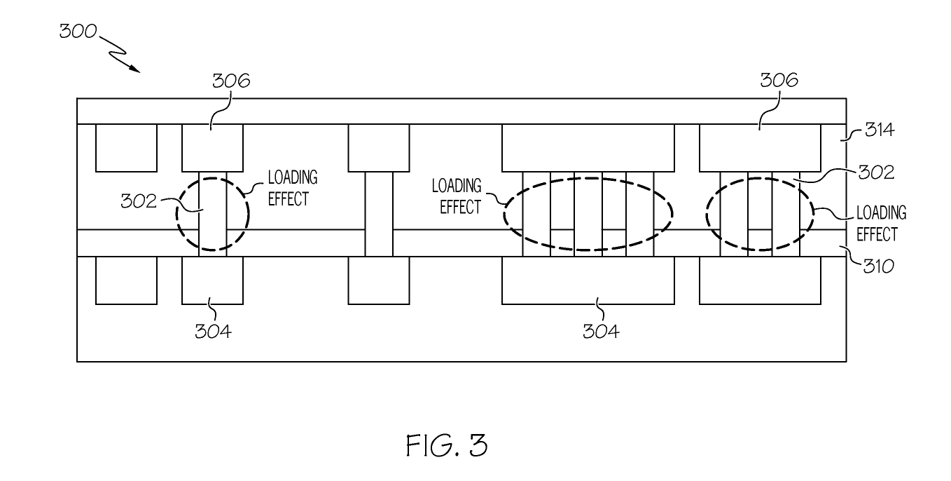

Next, referring to FIG. 3, details of kernel parameter e₁ for an etch process of IC 300 will be described in greater detail. As shown, e₁ may be a function of an etching loading effect for connecting via 302. As is known, etching loading effect pertains to a phenomenon occurring upon simultaneous etching of a pattern of a higher density and a pattern of a lower density. That is, due to a difference in etching rate of a material from one location to another, the amount of reaction products produced by etching becomes locally dense or sparse, and convection of a large amount of reaction products by etching causes a non-uniformity in etching rate. This etch-rate difference leads to CD variation between areas of high pattern density and low pattern density during the manufacture of photomasks.

Kernel parameter e₁ for an etch process may be defined by the following equation (3), which is a function of at least etching loading and selectivity:

e₁=f(etching loading,selectivity,etc.) Equation (3)

Again, it will be appreciated that many other parameters may be included in equation (3). However, for the sake of simplicity, only the effect of etching loading and selectivity on e₁ are considered in detail herein.

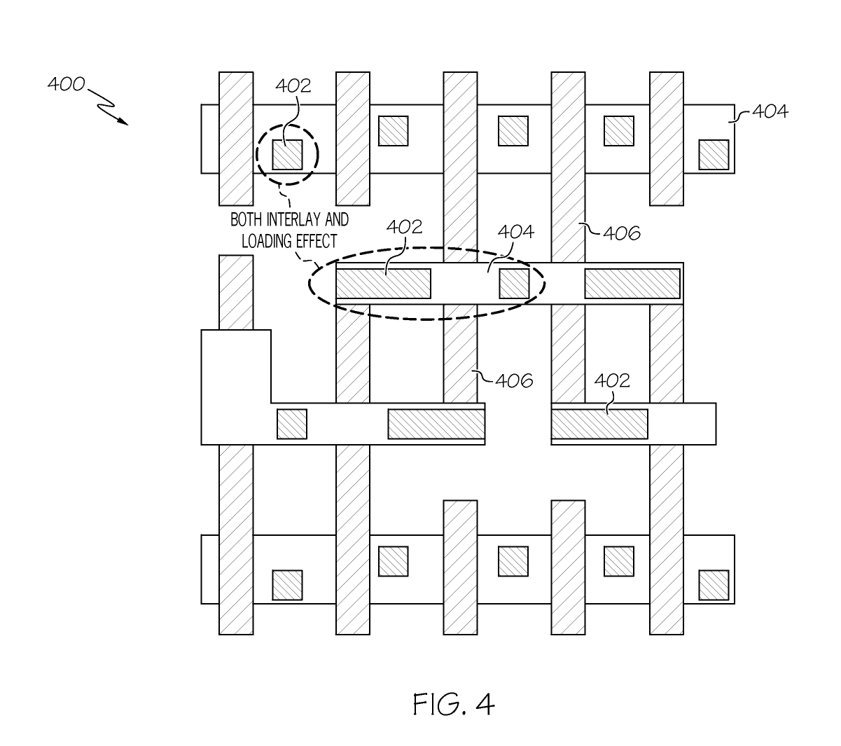

Referring now to FIG. 4, a top view of IC 400 will be shown and described in greater detail. As shown, multiple contacts 402 connect/intersect with a plurality of active layers 404 and polysilicon layers 406. Here, the interlayer and etch effect are considered for a connecting via in an area (shown by dashed lines) covering one or more contacts 402. A resultant intensity ‘I’ (Equation (1)) for a plurality of process variations (e.g., interlayer activity, etch process, etc.) is determined from kernels ρ and e₁, as defined by equations (2) and (3).

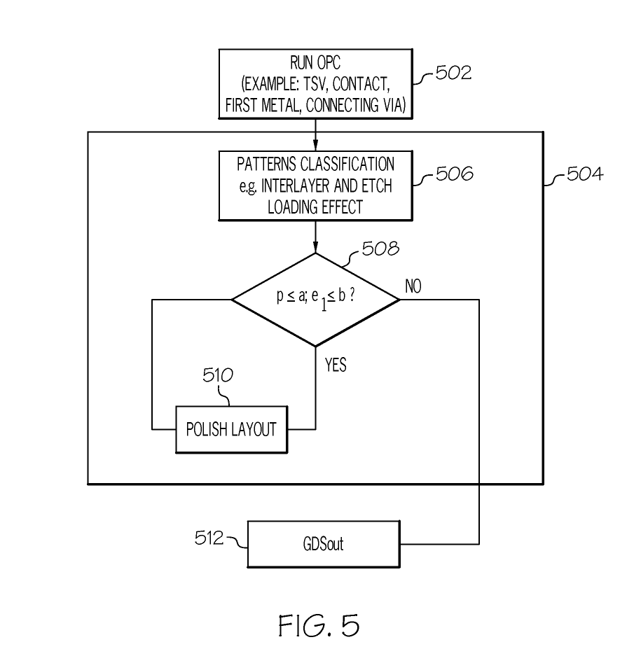

Intensity I is incorporated into an OPC model algorithm, as shown in FIG. 5. In this embodiment, an existing TSV, contact, and M1 layer OPC process is initially considered at 502. OPC model 504 is then applied, wherein a number of patterns are classified (506), e.g., according to the interlayer and etch loading effect. That is, as described above, kernel parameters ρ and e₁ are determined according to equations (2) and (3).

Next, OPC model 504 compares a value of kernel parameter ρ corresponding to the interlayer activity to a known inter-layer parameter ‘a’, and compares a value of kernel parameter e₁ corresponding to the etch process to a known etch parameter ‘b’. As shown at 508, it is evaluated whether ρ is approximately less than or equal to ‘a’, and if e₁ is approximately less than or equal to ‘b’. In this embodiment, ‘a’ represents a behavior of the inter-layer activity, e.g., how distances d1 and d2 (FIG. 2) affect the Vx etch outcome. Here, ‘a’ corresponds to calibration and/or wafer data that is collected prior, and correlates to d1 and d2 to represent the effect on a different layout. In one non-limiting example, process step 508 can be as follows: if f(d1,d2)=d2/d1 when ‘a’=1, then no interlayer compensation. However, if f(d1,d2)=d2/d1 when ‘a’ is smaller than 1, then move to layout polish step 510. It will be appreciated, of course, that f(d1,d2) could be more complicated depending on the wafer result and subsequent calibration step to determine how to compare parameters so that the outcome predicts the wafer result sufficiently well on design.

A similar process applies to known etch parameter ‘b’. In this embodiment, parameter ‘b’ describes a known etch behavior (e.g., etch loading, selectivity) during a via etch. It may be represented by an empirical equation (e.g., Gaussian), and utilize one or more optical parameters to identify the layout configuration. Again parameter ‘b could be established so that etch behavior could be appropriately compensated. In one non-limiting example, process step 508 can be as follows: if e₁=f(etching loading, selectivity)=f(Gaussian distribution equal to 0.6) is equal or smaller than 0.5, then move to layout polish step 510. However, if e₁=f(etching loading, selectivity)=f(Gaussian distribution equal to 0.6) is larger than 0.5, then no compensation is necessary, and a graphical output (e.g., GDSII) is created at 512. It will be appreciated, of course, that this process could be more complex depending on how sophisticated/accurate the simulation is desired to be.

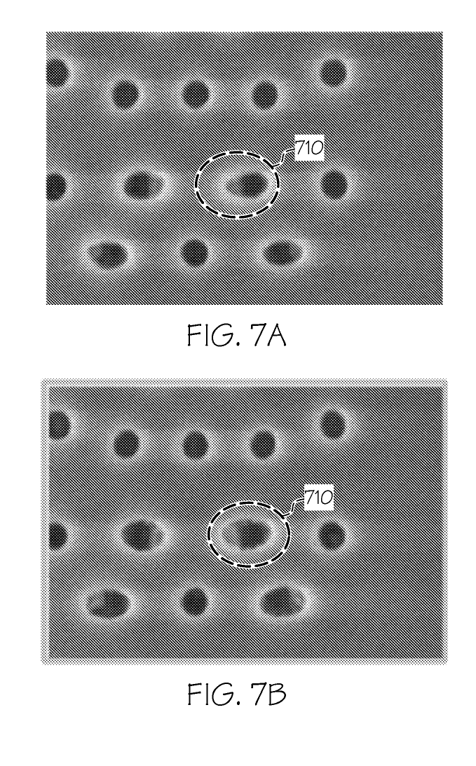

Referring now to FIG. 6, another embodiment of the invention will be shown and described. Here, OPC model 504 (FIG. 5) also can be implemented in other layers, e.g., polysilicon and CAREC. In this embodiment, it is known that the static random-access memory (SRAM) CAREC (shown by dashed line 610) exposure window is narrow, and after the contact etch process, the contact over poly coverage sometimes is small. In order to increase the CAREC coverage to the poly layer 606, one or more additional rectangular contact areas 602 can be added in poly layer 606, as shown, to consider the interlayer and etch effects on 610. The additional rectangular contact areas 602 for poly layer are model based. FIG. 6 shows the lithography simulation results for contact layer CAREC 610 after the polish layout (element 508 of FIG. 5) based on different etch selectivity. This can be further demonstrated by FIGS. 7A-B in which FIG. 7A shows the contact layer CAREC 710 prior to considering etch selectivity, and FIG. 7B shows the contact layer CAREC 710 after considering the etch selectivity based on kernel e₁.

It can be appreciated that the approaches disclosed herein can be used within a computer system for optimized advanced OPC modeling, as shown in FIG. 1. In this case, optimizer 110 can be provided, and one or more systems for performing the processes described in the invention can be obtained and deployed to computer infrastructure 104. To this extent, the deployment can comprise one or more of: (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 102 may be described in the general context of computer-executable instructions, such as program modules, being executed by a computer. Generally, program modules include routines, programs, people, components, logic, data structures, and so on that perform particular tasks or implements particular abstract data types. Exemplary computer system 102 may be practiced in distributed computing environments where tasks are performed by remote processing devices that are linked through a communications network. In a distributed computing environment, program modules may be located in both local and remote computer storage media including memory storage devices.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network.

Furthermore, as will be described herein, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations.

For example, an implementation of exemplary computer system 102 (FIG. 1) may be stored on or transmitted across some form of computer readable media. Computer readable media can be any available media that can be accessed by a computer. By way of example, and not limitation, computer readable media may comprise “computer storage media” and “communications media.”

“Computer-readable storage device” includes volatile and non-volatile, removable and non-removable computer storable media implemented in any method or technology for storage of information such as computer readable instructions, data structures, program modules, or other data. Computer storage device includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided approaches for modeling an OPC for a connecting via. While the invention has been particularly shown and described in conjunction with exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with the present invention. Furthermore, the methods according to the present invention may be implemented in association with the formation and/or processing of structures illustrated and described herein as well as in association with other structures not illustrated. Therefore, it is to be understood that the appended claims are intended to cover all such modifications and changes that fall within the true spirit of the invention.

What is claimed is:

1. A method for simulating a photolithographic process, the method comprising the computer implemented steps of:
receiving a plurality of kernels characterizing an optical proximity correction (OPC) model of a connecting via between a set of layers of an integrated circuit (IC) device, each of the kernels dependent on at least one process variation associated with the photolithographic process; and
determining a resultant intensity for a corresponding plurality of process variations from the plurality of kernels, wherein a process variation associated with at least one kernel corresponds to an interlayer activity, and wherein a process variation associated with at least another kernel corresponds to an etch process.

2. The method of claim 1, the connecting via comprising a through-silicon-via (TSV).

3. The method of claim 2, the etch process a function of etching loading effect and selectivity within the trench.

4. The method according to claim 1, the set of layers of the IC device comprising a contact layer and a M1 metal layer.

5. The method of claim 4, the interlayer activity a function of a first distance (d1) a second distance (d2), wherein d1 corresponds to a vertical thickness of a first layer formed over the contact layer, and d2 corresponds to a distance from a top surface of a TSV layer to a top surface of the first layer.

6. The method according to claim 1, the set of layers of the IC device comprising a polysilicon layer and a rectangular contact (CArec) layer.

7. The method according to claim 1, further comprising:
comparing a value of the at least one kernel corresponding to the interlayer activity to a known inter-layer parameter;
comparing a value of the at least another kernel corresponding to the etch process to a known etch parameter; and
generating a graphical output file after it is determined that no further compensation is required for a layout based on the comparison of the value of the at least one kernel corresponding to the interlayer activity to the known inter-layer parameter and the comparison of the value of the at least another kernel corresponding to the etch process to the known etch parameter.

8. The method according to claim 7, further comprising polishing the layout in the case that the value of the at least one kernel is approximately less than or equal to the known inter-layer parameter and the value of the at least another kernel is approximately less than or equal to the known etch parameter.

9. A system for simulating a photolithographic process of a connecting via using optical proximity correction (OPC), the system comprising:
a processor; and
a computer readable storage medium storing instructions, the instructions when executed by the processor causing the system to:
receive a plurality of kernels characterizing an OPC model of a connecting via between a set of layers of an integrated circuit (IC) device, each of the kernels dependent on at least one process variation associated with the photolithographic process; and
determine a resultant intensity for a corresponding plurality of process variations from the plurality of kernels, wherein a process variation associated with at least one kernel corresponds to an interlayer activity, and wherein a process variation associated with at least another kernel corresponds to an etch process.

10. The system of claim 9, the connecting via comprising a through-silicon-via (TSV).

11. The system of claim 9, the etch process a function of etching loading effect and selectivity within the trench.

12. The system according to claim 9, the set of layers of the IC device comprising one of: a contact layer and M1 metal layer, and a polysilicon layer and a rectangular contact (CArec) layer.

13. The system according to claim 12, the interlayer activity a function of a first distance (d1) and a second distance (d2), wherein d1 corresponds to a vertical thickness of a first layer formed over the contact layer, and d2 corresponds to a distance from a top surface of a TSV layer to a top surface of the first layer.

14. The system according to claim 9, the instructions further causing the system to:
compare a value of the at least one kernel corresponding to the interlayer activity to a known inter-layer parameter;
compare a value of the at least another kernel corresponding to the etch process to a known etch parameter; and
generate a graphical output file after it is determined that no further compensation is required for a layout based on the comparison of the value of the at least one kernel corresponding to the interlayer activity to the known inter-layer parameter and the comparison of the value of the at least another kernel corresponding to the etch process to the known etch parameter.

15. The method according to claim 14, the instructions further causing the system to polish the layout in the case that the value of the at least one kernel is approximately less than or equal to the known inter-layer parameter and the value of the at least another kernel is approximately less than or equal to the known etch parameter.

16. A method for modeling an optical proximity correction (OPC), the method comprising:
receiving a plurality of kernels characterizing a connecting via between a set of layers of an integrated circuit (IC) device, each of the kernels dependent on at least one process variation associated with the photolithographic process; and
determining, by a computer processor, a resultant intensity for a corresponding plurality of process variations from the plurality of kernels, wherein a process variation associated with at least one kernel corresponds to an interlayer activity, and wherein a process variation associated with at least another kernel corresponds to an etch process.

17. The method according to claim 16, the set of layers of the IC device comprising at least one of: a contact layer and a M1 metal layer, and a polysilicon layer and a rectangular contact (CArec) layer.

18. The method of claim 17, the interlayer activity being a function of a first distance (d1) and a second distance (d2), wherein d1 corresponds to a vertical thickness of a first layer formed over the contact layer, and d2 corresponds to a distance from a top surface of a TSV layer to a top surface of the first layer, and wherein the etch process is a function of etching loading effect and selectivity within the trench.

19. The method according to claim 16, further comprising:
comparing, by the computer processor, a value of the at least one kernel corresponding to the interlayer activity to a known inter-layer parameter;
comparing, by the computer processor, a value of the at least another kernel corresponding to the etch process to a known etch parameter; and
generating, by the computer processor, a graphical output file after it is determined that no further compensation is required for a layout based on the comparison of the value of the at least one kernel corresponding to the interlayer activity to the known inter-layer parameter and the comparison of the value of the at least another kernel corresponding to the etch process to the known etch parameter.

20. The method according to claim 19, further comprising polishing the layout in the case that the value of the at least one kernel is approximately less than or equal to the known inter-layer parameter and the value of the at least another kernel is approximately less than or equal to the known etch parameter.
